(19) United States
(12) Patent Application Publication
(10) Pub. No.: US 2006/0200565 A1
(43) Pub. Date: Sep. 7, 2006

(54) Methods and apparatus for flexible and transparent mediation of communication between software applications

(75) Inventors: Wee Teck Ng, Berkeley Heights, NJ (US); Gokul Chander Prabhakar, Somerset, NJ (US); Vatsan Rajagopalan, Whitehouse Station, NJ (US)

Correspondence Address: PRIEST & GOLDSTEIN, PLLC, 5015 SOUTHPARK DR, SUITE 230, DURHAM, NC, 27713, US

(73) Assignee: Lucent Technologies, Inc., Murray Hill, NJ (US)

(21) Appl. No.: 11/071,909

(22) Filed: Mar. 4, 2005

(51) Int. Cl. G06F 15/16

(52) U.S. Cl. 709/227

(57) ABSTRACT

Systems and techniques for mediating communication between applications over a message transport bus. A software wrapper includes a virtual bus wrapper presenting an interface to the applications, with the interface being presented such that the message transport bus is transparent to the applications. The wrapper also includes a bus specific wrapper to adapt the message transport bus to the virtual bus wrapper, as well as a support wrapper. Changes to the applications being supported or to the message transport bus can be accommodated by changes to the virtual bus wrapper or to the bus specific wrapper, respectively. In particular, changes to the bus specific wrapper allow migration to a new or changed message transport bus or a system using a different message transport bus without a need to adapt each application to the new bus.

### FIELD OF THE INVENTION

The present invention relates generally to improved systems and techniques for support of communication between software applications. More specifically, the invention relates to improved systems and techniques for mediating communication between software applications in a way that is transparent to the particular communication medium, such as a message transport bus, being used, and that is easily adaptable to changes, additions or substitutions to the applications and the communication medium.

### BACKGROUND OF THE INVENTION

Many communication systems, particularly large communication systems that have been in service for a long period of time, employ numerous instances of what are known as legacy applications. A legacy application is an application that predates newer applications that may be more flexible and efficient, but continues to be used because of its continued serviceability and the inconvenience and expense of replacing it. In order to allow for smooth communication between legacy products, many systems employ what are known as middleware products to facilitate communication. If a middleware product is used, legacy applications do not need to communicate directly with one another. Instead, each legacy application communicates with the middleware product, which provides appropriate message and data transfer and protocol handling. If a legacy application is replaced or changed, it is not necessary to change every other legacy application. Instead, changes only need to be made to the middleware product.

Many legacy applications have the potential to be used with different middleware products. For example, a legacy application deployed for a small customer application might use a simple middleware product hosted on a single computer, while the same legacy application deployed in a larger installation might use a more complex middleware supported on multiple computers. In order for a different middleware product to be used with a legacy application, steps must be taken to allow for communication between the application and the new middleware product.

Prior art approaches to migrating legacy applications from one middleware technology to another include the recoding of each legacy application to adapt the application to the new middleware. Another approach is to use a single standard middleware platform and to use software wrappers to map legacy applications to the target middleware platform. Both of these approaches require significant additional coding to accomplish migration from one middleware platform to another, because each legacy application, or the wrapper used for an individual legacy application, must be adapted to the new middleware platform. An alternative approach that avoids the need to adapt each legacy application is the use of a stateful gateway process to intercept messages from one application and relay them to another application. However, this approach reduces performance.

There exists, therefore, a need for systems and techniques that will allow changes, additions or substitutions to middleware products used with legacy applications with a minimum of adaptation and with a minimal impact on performance.

### SUMMARY OF THE INVENTION

In one exemplary embodiment, a software wrapper is implemented to mediate communication between one or more applications using a message transport bus. The message transport bus may suitably be implemented as a middleware package. The software wrapper includes a virtual bus wrapper presenting an interface adapted to the supported applications, such that the message transport bus is transparent to the applications. The software wrapper further includes a bus specific wrapper to adapt the virtual bus wrapper to the message transport bus being used, as well as a support wrapper to provide needed services to applications or message transport buses lacking these features. Upon initialization, code and data provided by the construction of the software wrapper is processed to create a body of executable code to carry out the functions of the software wrapper. Initialization is suitably performed using instructions in a configuration file and templates providing data used to adapt the software wrapper to the applications and to the message transport bus. Changes to the applications being supported or to the message transport bus can be accommodated by changes to the virtual bus wrapper or to the bus specific wrapper, respectively. In particular, changes to the bus specific wrapper allow migration to a new or changed message transport bus or a system using a different message transport bus without a need to adapt each application to the new bus.

A more complete understanding of the present invention, as well as further features and advantages, will be apparent from the following Detailed Description and the accompanying drawings.

### BRIEF DESCRIPTION OF THE DRAWINGS

FIG. 1 illustrates a system carrying out communication between applications according to an aspect of the present invention;

FIG. 2 illustrates details of a software wrapper for mediating between applications and a message transport bus, according to an aspect of the present invention;

FIG. 3 illustrates a system including components used to initialize and implement a software wrapper according to an aspect of the present invention;

FIG. 4A illustrates a prior art system for supporting communication between legacy applications and Java based clients;

FIG. 4B illustrates a system for supporting communication between legacy applications and Java based clients according to an aspect of the present invention; and

FIG. 5 illustrates a process of mediating communication between applications according to an aspect of the present invention.

### DETAILED DESCRIPTION

The present invention will be described more fully hereinafter with reference to the accompanying drawings, in which several exemplary embodiments of the invention are shown. This invention may, however, be embodied in various forms and should not be construed as limited to the embodiments set forth herein.

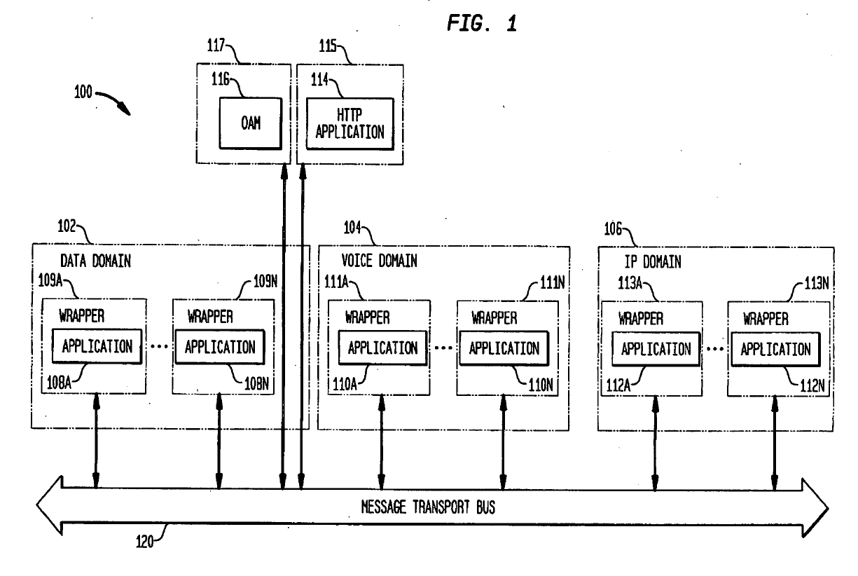

FIG. 1 illustrates a data, voice and IP system 100 according to an aspect of the present invention. The system 100 includes a data domain 102, a voice domain 104, and an Internet protocol (IP) domain 106. The data domain 102 includes a plurality of applications 108A . . . 108N, viewed here as enclosed by software wrappers 109A . . . 109N. The voice domain 104 includes a plurality of applications 110A . . . 110N, viewed as enclosed by software wrappers 111 . . . 111N. The IP domain 106 includes a plurality of applications 112A . . . 112N, viewed as enclosed by software wrappers 113A . . . 113N. The system 100 also includes an HTTP module 114, viewed as enclosed by a software wrapper 115, and an operations, administration and maintenance (OAM) module 116, viewed as enclosed by a software wrapper 117. Each of the domains 102, 104 and 106 may be envisioned as a data processing and communication system including one or more data processing units, with the modules, applications and the software wrappers envisioned as software packages operating on or distributed across one or more of the data processing units, but any exemplary implementation and hosting of the applications, modules and software wrappers shown herein is not necessary to the practice of the invention.

Communication between the various applications and modules is carried out over a message transport bus 120. The message transport bus 120 is a middleware package, designed to manage communication between the different applications without a need for each application to be specifically adapted to communicate with each of the other applications. The message transport bus 120 is typically implemented as a package having components hosted concurrently on each domain and components providing communication between the domains, in order to manage communication within and between the domains. Various software packages known as enterprise application integration (EAI) tools may be chosen to perform the functions of the message transport bus 120. Examples of such tools include UNIX message queues, BEA TUXEDO™ produced by BEA Systems, Inc., and common object request broker architecture (CORBA).

The various wrappers are implemented as intermediaries between the various applications and the message transport bus 120. The wrappers provide services that render the particular transport bus transparent to the applications, and render the applications transparent to the transport bus. The wrappers manage details specific to each application and to the transport bus 120, so that the applications that are communicating with one another are presented with a standardized interface. The communicating applications do not need to be adapted to the specific needs of the other applications, so that changes or substitutions affecting one application do not need to be accommodated by changes to the other application. A plurality of wrappers are shown here because adaptations are made to accommodate each application and module, so that it is convenient to think of the system 100 as implementing a plurality of wrappers, one for each application or module. However, it will be recognized that the actual implementation of the wrappers can be accommodated in any of a number of ways, for example by implementing the wrapper for each application as a single software component, by implementing a single software component to provide the necessary support for each application, with the single software component including any necessary adaptations to a particular application, or by implementing any desired combination of software components, with proper adaptation to applications served by the components.

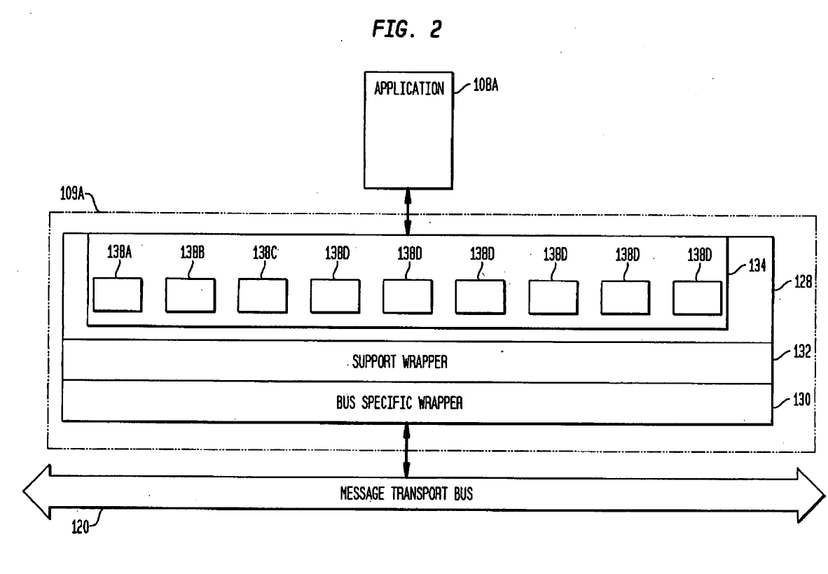

FIG. 2 illustrates the wrapper 109A for the application 108A in greater detail, showing the wrapper 109A in communication with the message transport bus 120 and the application 108A. The wrapper 109A comprises three layers. The different layers of the wrapper 109A are a “virtual” bus wrapper 128, a bus-specific wrapper 130 and a service support wrapper 132. The virtual bus wrapper 128 is adapted to the application 108A and the bus-specific wrapper is adapted to the message transport bus 120. A change to the application 108A therefore requires a change only to the virtual bus wrapper 128, and a change to the message transport bus 120 requires a change only to the bus-specific wrapper 130. The layers are implemented as software modules, and may be stored in a repository or library and assembled and processed as needed for a particular system implementation. As will be discussed in further detail below, initialization of the wrapper 109A causes generation of executable code mediating communication between the application 108A and the message transport bus 120. The executable code is generated using initialization and configuration information, and drawing data from templates and repositories, in order to combine the functions performed by the wrappers 128, 130 and 132 and generate a body of executable code implementing these combined functions.

The virtual bus wrapper 128 adapts the application 108A to a “virtual” bus. The virtual bus wrapper 128 provides an interface 134 to the virtual bus wrapper 128, providing services that allow the application 108A to communicate with the message transport bus without a need to specifically adapt the application 108A to the bus 120. Design of the interface 134 is preferably accomplished so as to export a vendor neutral interface that can be adapted to different application programming interfaces (APIs) used by legacy applications using standardized service innovation methods. The interface 134 presents its own standardized set of APIs to the application 108A. These APIs do not depend on the middleware package being used to implement the message transport bus 120. The following table presents some of the APIs that may be presented by the interface 134:

| | | |
|---|---|---|
| Classification | API | Description |

Application API

| | | |
|---|---|---|
| Message | send_msg( ), | Supported policies include |
| management | receive_msg( ) | synchronous or asynchronous |
| | | delivery, multiscan, message |
| | | order, load balancing, |
| | | message deliver semantics |
| | | (for example, at most once), |
| | | and prioritized handling. |
| | | Also abstracts various |
| | | messaging forms such as |
| | | send/receive, publish/sub- |
| | | scribe and the like |
| | send_to( ), | Explicit send/receive |
| | receive_from( ) | |
| Group and | group_init( ) | Initialize a group |
| membership | | structure for associating |
| management | | a set of applications |
| | group_join( ) | Associate with an already |
| | | formed (perhaps empty) group |
| | group_leave( ) | Disassociate from a group |
| | | structure |
| Resource | allocb( ), freep( ) | Allocate and free typed |
| management | | blocks respectively |
| | resource_init( ) | Initialize a resource |
| | resource_acquire( ) | Acquire and if needed |
| | | initialize a resource |
| | | atomically |
| | resource_free( ) | Release a resource in a |
| | | consistent state |
| Concurrency | thread_init( ) | Initialize an underlying |
| management | | threading system (optional) |
| | thread_invoke( ) | Invoke an operation on a |
| | | fixed thread (optional) |
| | thread_waitFor( ) | Wait for completion or a |
| | | request on a thread rather |
| | | than blocking the entire |
| | | process |
| Advanced | start/end_conv( ) | Stateful communication |
| communications | | using conversation mode |
| | start/end_trans( ) | Transaction monitor |
| | pub/sub_msg( ) | Publish/subscribe |
| | | communication |
| Security | set_security_pol( ) | Establish security policies |
| | | (usually at initialization) |
| | set_msg_security( ) | Establish secure message |
| | | policies (for example, |
| | | encryption) |
| Reliability | rel_enque( ) | Perform message queueing |
| | rel_deque( ) | and dequeueing reliably |
| | | using store and forward, |
| | | rerouting, etc., if needed. |
| | | Insure “at most once” |
| | | delivery semantics |

The bus specific wrapper 130 enables a dynamic binding between the APIs presented by the virtual bus wrapper 128 and APIs presented by the message transport bus 120. The bus specific wrapper 130 is preferably implemented as a shared library loaded dynamically at initialization of the wrapper 109A. The bus specific wrapper 130 is adapted to a specific middleware package, for example CORBA or BEA TUXEDO™. Thus, one alternative design of a bus specific wrapper 130 may be implemented in order to manage communication between the virtual bus wrapper 128 and an implementation of the message transport bus 120 comprising a CORBA middleware package. An alternative design of the bus specific wrapper would be adapted to manage communication using an implementation of the message transport bus 120 comprising a BEA TUXEDO™ middleware package. The wrapper 109A can be relatively easily changed to adapt to different middleware packages simply by substituting different implementations of the bus specific wrapper.

The service support wrapper 132 provides additional facilities such as name resolution and service location at run time to support message transports lacking these features. The service support wrapper 132 also provides uniform adaptation to the different conditions in message transports having features provided by the service support wrapper 132. Each such facility is implemented once per service type. An example of a service type is service discovery. If the application 108A requests a service but the virtual bus 128 does not include information identifying the application providing the service, the service discovery function of the service support wrapper 132 performs queries to identify the application providing the service and furnishes the identification information to the virtual bus wrapper 128. The virtual bus wrapper 128 is then able to point directly to the required application.

Use of a multilayered design including the virtual bus wrapper 128, the bus specific wrapper 130 and the service support wrapper 132 allows for simpler construction and use of the various components. A number of implementations of each wrapper can be created, with each implementation of a wrapper being appropriate to a set of entities communicating with the wrapper. Combinations of wrappers may then be selected in order to manage communication for a combination of entities. For example, a virtual bus wrapper may be created for a set of applications, with the virtual bus wrapper presenting an interface to the applications that is transparent to the particular middleware package being used for message transport. A bus specific wrapper may be created for a particular type of bus or middleware package, such as CORBA, with the bus specific wrapper being transparent to the applications communicating with the bus. Appropriate implementations of the virtual bus wrapper and the bus specific wrapper may be selected and used in combination to provide communication. Changes to the applications or the addition of new applications can be accommodated by selecting an appropriate version of the virtual bus wrapper 128 or modifying the virtual bus wrapper 128, and changes to the message transport bus 120 or use of a new middleware package as the message transport bus 120 can be accommodated by selecting a new version of the bus specific wrapper 130 or modifying the bus specific wrapper 130.

The virtual bus wrapper 128 presents the client interface 134 to the application 108A, and the bus-specific wrapper 130 adapts communication from the virtual bus 128 to the message transport bus 120. The client interface 134 manages communication between the application 108A and the virtual bus wrapper 128, presenting an interface to the application 108A which is independent of the message transport bus 120. The client interface 134 implements a number of application programming interface modules. Of particular interest are a message management module 138A, a request and response control module 138B, a service management module 138C and an advanced communication module 138D. Also implemented are a group and membership management module 138E, a resource management module 138F, a concurrency management module 138G, a security management module 138H and a reliability management module 1381. Each of the modules 138A-138I supports a number of application programming interfaces (APIs) that are invoked by a calling function. A calling function may be, for example, a function executed as part of the application 108A, and may invoke an API presented by the virtual bus wrapper 128 in order to request services from the virtual bus wrapper 128.

The message management module 138A provides application programming interfaces (APIs) that are implemented so as to insure message bus independence. Message bus independence allows for communication by the application 108A regardless of the specific implementation of the message transport bus 120. The message management module 138A provides support for different messaging techniques, for example, point to point and publish/subscribe. Different transport platforms that may be used as the message transport bus 120 may exhibit different capabilities, and the virtual bus wrapper 128 enables the use of any underlying message facility in a given transport platform.

The message management module 138A also allows applications, such as the application 108A, to specify different control policies on messaging such as synchronous requests, asynchronous requests with receipts, and asynchronous one way notification. Message delivery order can also be specified as part of message construction or by setting message attributes such as in band or out of band. In addition, prioritized message handling is supported so as to allow a message with a higher priority to be served before a lower priority message.

The message management module 138A provides support for a desired transport method without a need for specification by the application 110A. The message management module 138A receives a generic transport handle, obtained earlier by the application 108A. The message management module 138A retrieves or obtains information describing the messaging structure being used. The message management module 138A then performs needed mapping, encoding and decoding and translation to support message transfer between the application 108A and the message transport bus 120.

Applications typically take on the roles of either clients, that is, requesting services from other resources, or servers, that is, receiving and responding to requests. The role of an application may change over time, or an application may serve in dual roles, that is, requesting services from some entities and providing services to others. The request and response control module 138B supports changes in function and dual function performance of applications and generates appropriate scaffolding code to support changes in role between client and server.

The wrapper 109A preferably supports request forwarding. Request forwarding allows one application, such as the application 108A, to forward a request to another application, for example the application 111A of FIG. 1. Such forwarding can be accomplished through a request_forward API using a send_to API. These APIs are provided by the message management module 138A. Invoking the APIs allows for direction of a request to a specific entity.

In addition, the group and membership management module 138E also provides facilities for management of request forwarding. An application or a server can advertise its services dynamically when it joins a group using a group_join API, implemented to support group and resource management. Such advertising of services facilitates transparent load sharing of requests and request forwarding. Request forwarding can also be used to implement security measures such as third party authentication. However, if delegation or advertisement occurs between different applications operating in different servers, or when a group includes applications distributed across several different servers, delegation and advertisement becomes complex. Therefore, the virtual bus wrapper 128 includes a service management module 138C, which provides location transparency by decoupling service location from the application requiring a service. The service management module 138C provides support for various service location policies, such as “nearest” or “round robin”. These policies can be explicitly specified, for example, through an argument explicitly specified when invoking a particular API, or through choices made at initialization of the module 124. Service location policies are implemented by the support wrapper 132. When a request involving location policy is received, it is passed to the service management module 138C. The service management module 138C passes the location policy selection to the service wrapper 132, which provides the support needed to direct the request to the proper location according to the location policy. The service management module 138C can also implement optional server application callback initialization functions in order to accommodate applications with special needs.

The virtual bus 120 also includes an advanced communication module 138D, to support additional communication features such as stateful communication, also known as conversations, message transactions, and event notification mechanisms, for example, receipt of a message. APIs include APIs to start and end conversations and to start and end transactions. In addition, the advanced communication module 138D can also support an optional user defined event handler to be called when messages are sent and received in order to manage application specific bookkeeping, such as billing, related to the messages.

Management and coordination of communication between an application communicating with the virtual bus 128, and the message transport bus 120, is achieved by linking the virtual bus wrapped code generated by the interaction of the application and the virtual bus wrapper 128 with a bus specific library. The virtual bus wrapped code is code and other data and communication generated by the operation of the virtual bus 109A in response to communication from the application 108A. The function of the library is performed by the bus specific wrapper 130, which is preferably implemented as a shared library dynamically loaded at run time, that is, at initialization of the software wrapper 109A.

Implementation of a wrapper typically comprises the examination of the various APIs, library information and other data comprising the layers of the wrapper, and the use of this information, as well as other information drawn from libraries and other repositories, to construct a body of executable code carrying out the functions of the wrapper 109A. This construction may be performed by a data processing unit, suitably a unit hosting the application and wrapper, as well as the libraries used in construction of the executable code and configuration and operations, administration and maintenance files used in initialization of the wrapper.

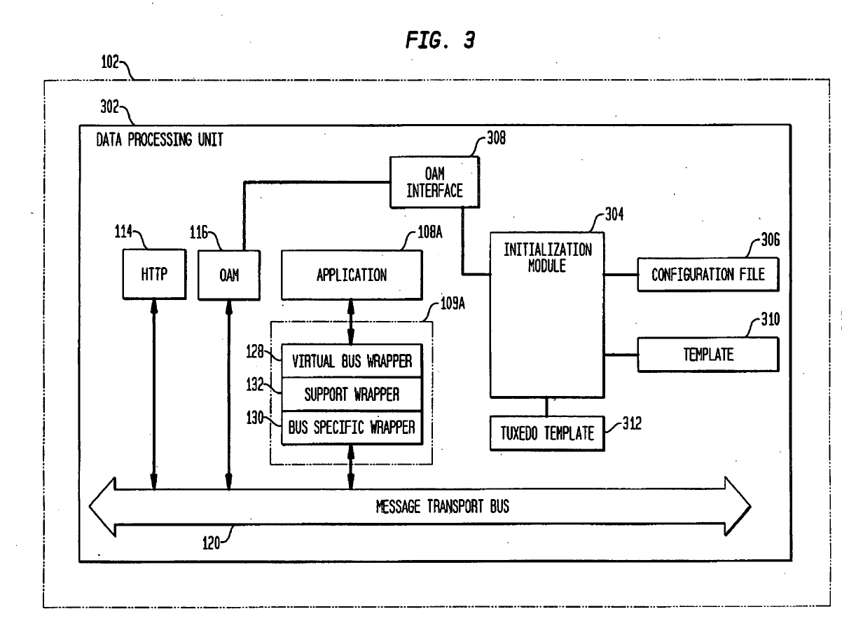

FIG. 3 illustrates a data processing unit 302, operating as part of the data domain 102 and hosting the Http and OAM modules 114 and 116, respectively, and the application 108A, as well as the wrapper 109A. The data processing unit also hosts appropriate portions of the message transport bus 120, and an initialization module 304, which constructs an executable code package to carry out the functions of the wrapper 109A in facilitating communication between the application 108A and the message transport bus 120, using the commands and data comprising the wrapper 109A, as well as various libraries and repositories including data and instructions. In the present example, the message transport bus 120 is implemented as an EAI TUXEDO™ bus.

The initialization module 304 has access to a number of code libraries and templates used to construct scaffolding needed to manage communication between the application 108A and the message transport bus 120. The libraries include a configuration file 306, constructed at initialization of the wrapper 109A and used to manage the operation of the wrapper 109A. The configuration file 306 preferably comprises a repository hosting extensible markup language (XML) files for startup settings, build instructions and for storage of log files. The libraries also include an OAM interface file 308, used to store APIs for management of system startup, shutdown and run time monitoring.

The configuration files include a startup file providing instructions for startup functions. The startup file is preferably in the form of an XML file. In addition, the OAM interface includes a build file providing build instructions, used to create a structure to provide linkages allowing for communication between the application 108A and the message transport bus 120. The build file is preferably also in the form of an XML file.

Initialization of the wrapper 109A may suitably comprise three steps, directed by the startup file and the build file. At initialization, the configuration files employed by the application 108A are transformed to standardized XML format used by the virtual bus wrapper 109A. The transformation is accomplished using extensible stylesheet language transformations (XSLT). Procedural wrapper code generation is then performed. Linkages between the procedural wrapper code and the bus-specific wrapper are then constructed, and finally the code resulting from construction of the linkages is combined with support tier code used by the support layer 132. After the various initializations and linkages are performed, the application 108A is able to communicate with the message transport bus 120.

A procedure template 310 is used to automate procedural wrapper code generation. Code is generated for each procedure performed as part of the application 108A. The procedure wrapper template 310 is a set of instructions for automating code generation, and the procedure directed by the template 310 includes three steps. The first step is a precondition step performing any needed initializations and argument mapping. Next, a command step constructs code for executing the procedure. The last step performs any needed cleanup and dispatches the result to the calling or requesting entity, such as another application or a procedure included in another application.

A template such as the template 310 may be used to provide for application and configuration file scaffolding. In addition, result dispatch must be managed with care, because the application responding to a request from a client may be different from the application that initially received the request. This difference may result from conditions such as service forwarding or load balancing.

As an example, consider construction of scaffolding for a single C++ function WM_CREATE. The function is adapted to an EAI TUXEDO™ message transport bus, and assumes that the EAI tool will determine which services it is supporting and will also receive messages from the supported service. After processing the message, the function will act as a client and will forward the message to another server via the tp_forward procedure supported by TUXEDO™.

The virtual bus wrapper 128 generates appropriate C code scaffolding from a TUXEDO™ template 312. The TUXEDO™ template 312 includes code directing the initialization of resources and identification of the service being supported. Then, the bus specific wrapper 130 waits in a message loop until it receives a message destined for the supporting service. Next, the bus specific wrapper 130 decodes the message to the format used by the application 108A and invokes an appropriate function provided by the application 108A. This process of decoding the message and invoking the application continues until the application is shut down via a signal.

In addition, the virtual bus wrapper 128 performs initialization tasks specific to the application 108A, for example message timeouts and signal scaffolding. The bus specific wrapper 130 also performs any needed message encoding and decoding to perform any required format conversions, as well as procedure mappings between the API presented by the message transport bus and the APIs presented by the application 108A. Once initialization is complete, the wrapper 109A is able to mediate communication between the application 108A and the message transport bus 120.

The initialization of a single wrapper 109A for communication with a single application 108A is discussed here for simplicity of illustration and explanation, but it will be recognized that initialization of a plurality of wrappers, or more complex wrappers supporting communication with a number of applications, is accomplished in a similar way.

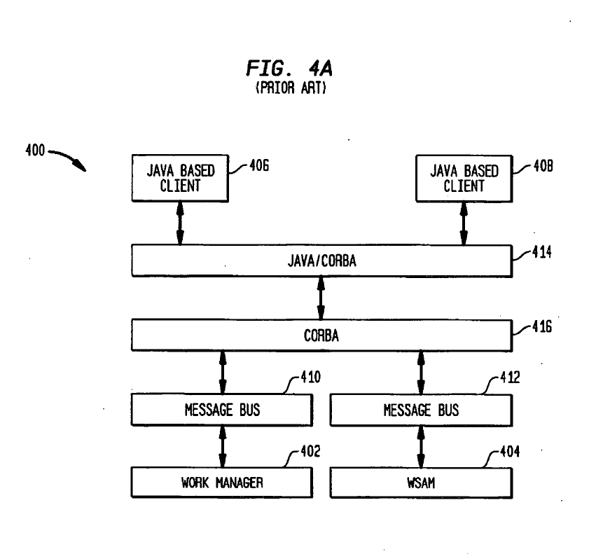

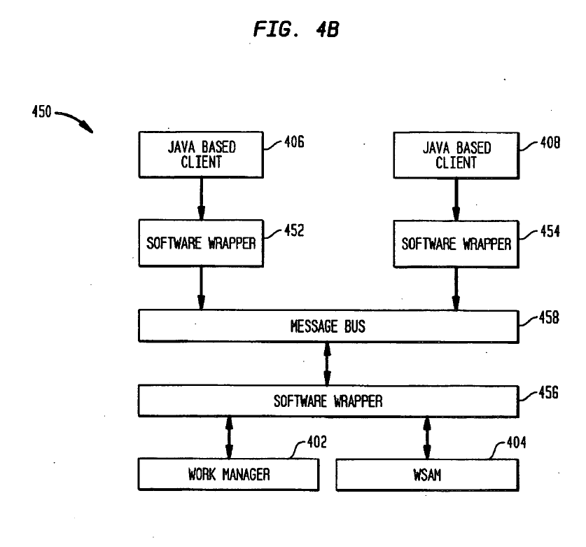

FIGS. 4A and 4B illustrate the use of software wrappers according to the present invention to migrate an application between different message transport buses. In the present illustrative example, the application is a legacy application originally written for the BEA Tuxedo™ transport bus. A software wrapper according to an aspect of the present invention adapts the application to operate with Unix transport queues, and a relatively simple change adapts the application to operate with the Java Message service.

FIG. 4A illustrates a system 400, comprising an application 402 engaging in communication using a message transport bus 404. The transport bus 404 is implemented using message transport queues. The application 402 was originally designed to communicate using BEA Tuxedo™, but a software wrapper 406 has been provided to facilitate operation of the application using the message transport bus 404. The software wrapper 406 comprises a virtual bus 408, a bus specific wrapper 410 and a support services wrapper 412. The various components are implemented using the following C++ code:

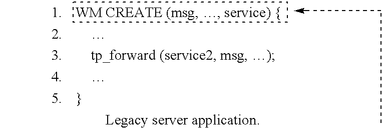

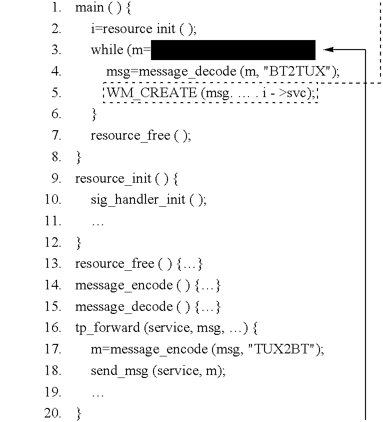

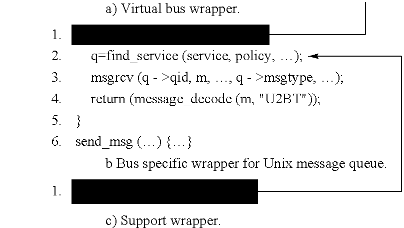

The code section labeled “Legacy Server Application” corresponds to the application 402, the code section labeled “a) Virtual bus wrapper” corresponds to the virtual bus wrapper 408, the code section labeled “b) Bus specific wrapper for Unix message queue” corresponds to the virtual bus wrapper 410, and the code section labeled “c) Support wrapper” corresponds to the support wrapper 412.

FIG. 4B illustrates the system 450, showing the application 402 adapted to operate with the message transport bus 452. In the present illustrative example, the message transport bus 452 is implemented using the Java message system. Communication between the application 402 and the bus 452 is facilitated by the software wrapper 454. The software wrapper 454 includes the virtual bus wrapper 408, unchanged from that illustrated in FIG. 4A and discussed above. The software wrapper also includes a bus specific wrapper 454, facilitating communication between the virtual bus wrapper 408 and the bus 452. No support wrapper is provided in the present example, because no special support services are required for interaction between the virtual bus wrapper 408 and the bus 452. The application 402 and the software wrapper 454 are implemented using the following C++ code:

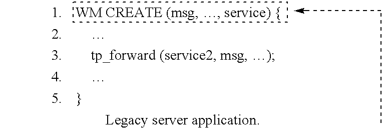

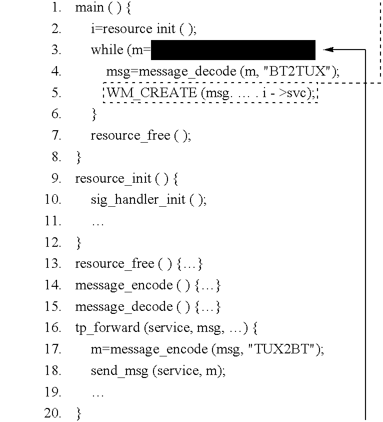

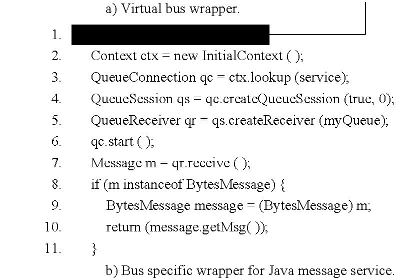

The code section labeled “Legacy Server Application” corresponds to the application 402, the code section labeled “a) Virtual bus wrapper” corresponds to the virtual bus wrapper 408 and the code section labeled “b) Bus specific wrapper for Unix message queue” corresponds to the virtual bus wrapper 456. The application 402 and the virtual bus wrapper 408 are carried over unchanged to the system 450, with the new bus specific wrapper 456 being substituted for the bus specific wrapper 410.

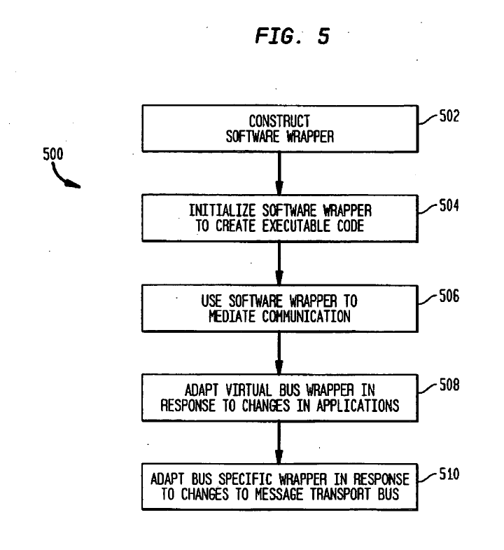

FIGS. 5A and 5B illustrate differences between a prior art system using gateways to support communication between legacy application and clients employing newer technology, and a system according to an aspect of the present invention using software wrappers to support communication between the legacy application and the clients. FIG. 5A illustrates a prior art system 500, employing legacy applications, namely a work manager 502 and a wireless service activation manager (WSAM™) 504, communicating with Java based clients 506 and 508. The work manager 502 uses a dedicated TUXEDO™ message bus 510 and the WSAM™ 504 also uses a dedicated TUXEDO™ message bus 512. The clients 506 and 508 communicate with the legacy applications using a CORBA interface 514 using CORBA APIs. The CORBA interface 514 relays messages to the legacy applications using a CORBA to TUXEDO™ gateway 516.

FIG. 5B illustrates a system 550, using software wrappers in accordance with the present invention, which eliminates the need for the gateways 514 and 516. The system 550 includes the work manager 502 and the WSAM™ 504, as well as the Java based clients 506 and 508, but the CORBA interface 514 and the gateway 516 have been eliminated. Instead, software wrappers 552 and 554 have been implemented to support the clients 506 and 508, respectively, and a software wrapper 556 has been implemented to support the applications 502 and 504. A bus 558 has been implemented for communication between the legacy applications 502 and 504 and the clients 506 and 508, and the wrappers 552, 554 and 556 have each adapted their supported applications to the same shared bus 558. The wrappers may be implemented using C++ and by providing Java APIs using Java JNI. Use of the wrappers bypasses two levels of gateways, replacing the entire set of gateway processes with wrapper code that is dynamically linked with the Java clients 502 and 504 at initialization. This approach yields a speed an order of magnitude faster than that provided by the system 500 illustrated in FIG. 5A.

FIG. 6 illustrates a process 600 of communication management according to an aspect of the present invention. The process 600 may suitably be implemented using a system similar to that of the system 100 of FIG. 1, using the components illustrated in FIGS. 1-3. At step 602, a software wrapper is constructed so as to support communication between two or more applications over a message transport bus. Communication is carried out in such a way that the particular message bus used is transparent to the applications. The software wrapper is constructed so that each application to be supported is presented with an interface adapted to that application. The software wrapper preferably includes a virtual bus wrapper presenting the interface adapted to the applications and providing a standardized virtual bus, a bus specific wrapper adapted to the message transport bus being used and mediating communication between the virtual bus wrapper and the message transport bus. The software wrapper also includes a support wrapper to provide specialized services needed to support communication.

Next, at step 604, upon initialization of the software wrapper, code and data presented by the wrapper is processed to create a body of executable code to carry out the wrapper functions. Initialization is suitably performed using a stored configuration file and templates providing data used for adapting the software wrapper to the applications being supported and to the message transport bus being used.

At step 606, the software wrapper is used to mediate communication between applications. At step 608, carried out in response to addition of or changes to one or more applications, the virtual bus is adapted so as to support the new or changed application, and initialization is performed. At step 610, carried out in response to changes to the message transport bus, substitution of a different message transport bus or migration of the applications to a new system using a different message transport bus, the bus specific wrapper is adapted to support the new or changed message transport bus and initialization is performed.

While the present invention is disclosed in the context of several embodiments, it will be recognized that a wide variety of implementations may be employed by persons of ordinary skill in the art consistent with the above discussion and the claims which follow below.

We claim:

1. An application interface for adapting communication between one or more applications and a message transport bus, comprising:
a virtual bus presenting an interface to the applications, the interface being adapted to the applications and independent of the message transport bus; and
a bus specific interface for managing communication between the virtual bus and the message transport bus, the bus specific interface being adapted to the message transport bus and providing communication between the virtual bus and the message transport bus independent of the applications.

2. The application interface of claim 1, wherein the application interface is capable of supporting a number of different applications and a number of different implementations of message transport buses, and wherein the application interface further comprises a support interface to provide services required by a particular application or message transport bus implementation but not provided by an application or message transport bus implementation with which communication is being carried out.

3. The application interface of claim 2, wherein the application interface can adapt communication to a new or altered message transport bus by adaptation of the bus specific interface without a need for adaptation of the virtual bus interface or the applications.

4. The application interface of claim 2, wherein the application interface can adapt communication to a new, altered or added application by adaptation of the virtual bus interface without a need for adaptation of the bus specific interface or the applications.

5. The application interface of claim 4, wherein the bus specific interface comprises a bus specific library.

6. The application interface of claim 5, wherein virtual bus wrapped code generated by interaction between the application and the virtual bus is linked to the bus specific interface.

7. The application interface of claim 2, wherein the application interface is initialized by constructing a body of executable code to carry out the functions of the application interface, initialization being performed under the control of instructions in a configuration file and using templates to direct adaptation to the applications and to the message transport bus.

8. The application interface of claim 7, wherein initialization includes using code libraries and templates to construct scaffolding needed to manage communication between an application and the message transport bus.

9. The application interface of claim 8, wherein initialization includes transforming configuration files employed by the application to standardized XML format used by the virtual bus interface, generating procedural wrapper code, constructing linkages between the procedural wrapper code and the bus specific wrapper and combining the code resulting from construction of the linkages is combined with support tier code used by the support interface.

10. The application interface of claim 9, wherein initialization further comprises automating procedural wrapper code generation using a procedure template.

11. A method of managing communication between one or more applications and a message transport bus, comprising the steps of:
presenting an application interface to the applications, the application interface being independent of the message transport bus;
receiving communications from the applications; and
adapting the communications to the message transport bus through a bus specific interface, the bus specific interface being independent of the applications.

12. The method of claim 11, wherein the bus specific interface comprises a bus specific library.

13. The method of claim 12, wherein virtual bus wrapped code generated by interaction between the application and the virtual bus is linked to the bus specific interface.

14. The method of claim 11, further comprising a step of providing support services required by an application or message bus but not supported by the application or message transport bus with which communication is being carried out.

15. The method of claim 14, further comprising a step of responding to a change in or substitution of the message transport bus by adapting the bus interface to the changed or new message transport bus without a need for adaptation of the application interface or the applications.

16. The method of claim 14, further comprising a step of responding to a change in or substitution or addition of an application by adapting the application interface to the new or changed application without a need for adaptation of the bus interface or message transport bus.

17. The method of claim 14, wherein the steps of presenting the application interface and the bus interface include performing an initialization to construct the interfaces using instructions in a configuration file and in templates providing direction for adaptation of the interfaces to the applications and to the message transport bus.

18. The method of claim 17, wherein the step of performing an initialization includes using code libraries and templates to construct scaffolding needed to manage communication between an application and the message transport bus.

19. The method of claim 18, wherein the step of performing an initialization includes transforming configuration files employed by the application to standardized XML format used by the virtual bus interface, generating procedural wrapper code, constructing linkages between the procedural wrapper code and the bus specific interface and combining the code resulting from construction of the linkages is combined with support tier code used in providing support services.

20. The method of claim 19, further comprising automating procedural wrapper code generation using a procedure template.
